(19) United States
(12) Patent Application Publication
(10) Pub. No.: US 2019/0182267 A1
(43) Pub. Date: Jun. 13, 2019

(54) VEHICLE SECURITY MANAGER

(71) Applicant: International Business Machines Corporation, Armonk, NY (US)

(72) Inventors: Derek Aher, Kinsale Road (IE); Yair Allouche, Dvira (IL); Jack Hanley, Cork (IE); Patrick Hourigan, Cork (IE); Ravid Sagy, Beit Yizhack (IL); Mauro Silva, Cork (IE)

(21) Appl. No.: 15/839,897

(22) Filed: Dec. 13, 2017

(51) Int. Cl. H04L 29/06; H04L 29/08

(52) U.S. Cl. CPC H04L 63/1408; H04L 2012/40215; H04L 67/12

(57) ABSTRACT

A system comprising: a software agent stored on a non-transient computer-readable storage medium in a motor vehicle, the software agent comprising instructions that cause a processor in the motor vehicle to: monitor, in real time (i) events occurring in an operating system of the motor vehicle and any application running thereon, (ii) messages transmitted by Electronic Control Units (ECUs) of the motor vehicle over an in-vehicle network of the motor vehicle, and (iii) network activity between the motor vehicle and external network resources; detect suspicious events, messages, and network activity, in the monitored events, messages, and network activity, respectively; repeatedly execute Stateful Event Processing (SEP) on a combination of the detected suspicious events, messages, and network activity; and infer potential computer security threats based on results of the SEP.

### BACKGROUND

The invention relates to the field of vehicle cyber security.

Modern vehicles are controlled and monitored by numerous embedded ECUs (electronic control units) that coordinate their operations by communicating over one or more internal network buses, such as a Controller Area Network (CAN) bus. In addition, modern vehicles are becoming increasingly connected to external networks through a variety of interfaces, such as RFID, Bluetooth, Dedicated Short Range Communication (DSRC), WiFi, and cellular. This connectivity facilitates a variety of services, including telematics, navigation, and safety features, which provide significant benefits for automakers, aftermarket vendors, fleet managers, and car owners. However, these connectivity capabilities can also introduce security and privacy concerns.

Research has highlighted the vulnerability of modern vehicles to cyber-attacks. For example, it has been shown that it is possible to evade network defenses and infect vehicle ECUs with malware to control a wide range of critical vehicle functions, such as engine and braking systems. Several remote exploitation techniques have been demonstrated, using multiple attack vectors (including Bluetooth and cellular communications), which allowed remote control over the vehicle, as well as eavesdropping on the passengers' cabin and tracking the vehicle's location. Additional research showed that the wireless interfaces of such systems as tire pressure monitoring, passive keyless entry, and engine start-up, can all be hacked.

Several mechanisms for improving vehicle security have been proposed by the security industry and in academia. These include, for example, authentication and encryption; segregating the vehicle's internal network using security gateways; and using firewalls. However, none of these systems offer real time systemic security event detection and management.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a system comprising: a software agent stored on a non-transient computer-readable storage medium in a motor vehicle, the software agent comprising instructions that cause a processor in the motor vehicle to monitor, in real time (i) events occurring in an operating system of the motor vehicle and any application running thereon, (ii) messages transmitted by Electronic Control Units (ECUs) of the motor vehicle over an in-vehicle network of the motor vehicle, and (iii) network activity between the motor vehicle and external network resources; detect suspicious events, messages, and network activity, in the monitored events, messages, and network activity, respectively; repeatedly execute Stateful Event Processing (SEP) on a combination of the detected suspicious events, messages, and network activity; and infer potential computer security threats based on results of the SEP.

In some embodiments, the system further comprises a remote software agent controller communicatively connected to the software agent.

In some embodiments, the instructions further cause the processor to execute edge analytics on the results of the SEP, and wherein said edge analytics lead to a response action selected from the group consisting of: transmitting information to the remote software agent controller, transmitting information to a remote security incident and event manager (SIEM), executing one or more commands with respect to a said ECU of the motor vehicle, and issuing an alert to an operator of the motor vehicle. In some embodiments, the edge analytics further lead to at least one of data normalization, data prioritization, and data reduction of the transmitted information.

In some embodiments, the transmitted information comprises at least some of the detected suspicious events, messages, and network activity. In some embodiments, the transmitted information further comprises at least one of: (i) multiple said events temporally adjacent each of the detected suspicious events, (ii) multiple said messages temporally adjacent each of the detected suspicious messages, and (iii) said network activity temporally adjacent the detected suspicious network activity.

In some embodiments, the instructions further cause the processor to receive, from the remote software agent controller, configuration files defining at least some of the suspicious events, messages, and network activity.

In some embodiments, the system further comprises one or more additional software agents, wherein each of said one or more additional software agents is associated with a different motor vehicle, and wherein said configuration files are based, at least in part, on suspicious events, messages, and network activity detected by at least some of said one or more additional software agents.

In some embodiments, the detecting and the inferring are based, at least in part, on the received configurations files. In some embodiments, the instructions further cause the processor to log, in a persistent storage, at least some of the suspicious events, messages, and network activity, wherein the logging is based on the configuration files.

In some embodiments, the instructions further cause the processor to transmit information to at least one of the remote software agent controller and the SIEM in response to an information request query.

In some embodiments, the alert issued to the operator of the vehicle is selected from the group comprising audio, textual, and visual alerts.

In some embodiments, the instructions further cause the processor to detect a malfunctioning system of the vehicle, based on the results of the SEP.

In some embodiments, the instructions further cause the processor to generate an inventory of said ECUs of the motor vehicle and transmit said inventory to the remote software agent.

In some embodiments, the instructions further cause the processor to generate a list of authorized and unauthorized mobile devices, and wherein the detecting of suspicious events, messages, and network activity comprises, at least in part, determining whether a mobile device attempting to communicatively connect with the motor vehicle is associated with the list of authorized and unauthorized mobile devices.

In some embodiments, the instructions further cause the processor to generate a list of authorized and unauthorized network Internet Protocol (IP) addresses, and wherein the detecting of suspicious events, messages, and network activity comprises, at least in part, determining whether an IP address is associated with the list of authorized and unauthorized network IP addresses.

The is also provided, in accordance with an embodiments, a method comprising using at least one hardware processor of a motor vehicle for monitoring, in real time (i) events occurring in an operating system of the motor vehicle and any application running thereon, (ii) messages transmitted by Electronic Control Units (ECUs) of the motor vehicle over an in-vehicle network of the motor vehicle, (iii) network activity between the motor vehicle and external network resources; detecting suspicious events, messages, and network activity, in the monitored events, messages, and network activity, respectively; repeatedly executing Stateful Event Processing (SEP) on a combination of the detected suspicious events, messages, and network activity; and inferring potential computer security threats based on results of the SEP.

In some embodiments, the method further comprises communicating with a remote software agent controller.

In some embodiments, the method further comprises executing edge analytics on the results of the SEP, wherein said edge analytics lead to a response action selected from the group consisting of: transmitting information to the remote software agent controller, transmitting information to a remote security incident and event manager (STEM), executing one or more commands with respect to a said ECU of the motor vehicle, and issuing an alert to an operator of the motor vehicle.

In some embodiments, the edge analytics further lead to at least one of data normalization, data prioritization, and data reduction of the transmitted information.

There is further provided, in accordance with an embodiment, a computer program product, the computer program product comprising a non-transitory computer-readable storage medium in a motor vehicle having program code embodied therewith, the program code executable by at least one hardware processor in the motor vehicle to monitor, in real time (i) events occurring in an operating system of the motor vehicle and any application running thereon, (ii) messages transmitted by Electronic Control Units (ECUs) of the motor vehicle over an in-vehicle network of the motor vehicle, and (iii) network activity between the motor vehicle and external network resources; detect suspicious events, messages, and network activity, in the monitored events, messages, and network activity, respectively; repeatedly execute Stateful Event Processing (SEP) on a combination of the detected suspicious events, messages, and network activity; and infer potential computer security threats based on results of the SEP.

In some embodiments, the computer program product further comprises executing edge analytics on the results of the SEP, wherein said edge analytics lead to a response action selected from the group consisting of: transmitting information to a remote software agent controller, transmitting information to a remote security incident and event manager (SIEM), executing one or more commands with respect to a said ECU of the motor vehicle, and issuing an alert to an operator of the motor vehicle. In some embodiments, the edge analytics further lead to at least one of data normalization, data prioritization, and data reduction of the transmitted information.

There is further provided, in an embodiment, a system for motor vehicle fleet cyber security threat detection and mitigation, the system comprising a plurality of motor vehicles, wherein each of said motor vehicles comprises a software agent stored on a non-transient computer-readable storage medium in the motor vehicle, the software agent comprising instructions that cause a processor in the motor vehicle to monitor, in real time: (i) events occurring in an operating system of the motor vehicle and any application running thereon, (ii) messages transmitted by Electronic Control Units (ECUs) of the motor vehicle over an in-vehicle network of the motor vehicle, and (iii) network activity between the motor vehicle and external network resources; detect suspicious events, messages, and network activity, in the monitored events, messages, and network activity, respectively; repeatedly execute Stateful Event Processing (SEP) on a combination of the detected suspicious events, messages, and network activity; and infer potential computer security threats based on results of the SEP.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1A is a block diagram of a vehicle security system, according to certain embodiments of the present disclosure;

FIG. 1B is a block diagram of a common vehicular ECU and CAN bus system; and

FIG. 2A illustrates a startup use case scenario of a vehicle security system, according to certain embodiments of the present disclosure;

FIG. 2B illustrates an event processing use case scenario of a vehicle security system, according to certain embodiments of the present disclosure; and

FIG. 2C illustrates several additional use case scenarios of a vehicle security system, according to certain embodiments of the present disclosure.

### DETAILED DESCRIPTION

The subject matter disclosed herein relates to real-time cyber security threat detection and mitigation in a motor vehicle. The disclosed system combines real-time monitoring of vehicle systems with Stateful Event Processing (SEP) capabilities that can cross-correlate data from different in-vehicle and external sources, to identify potential threats, detect and prevent security breaches, and providing forensic information to determine how a security incident occurred as well as its possible impact.

As noted above, in modern vehicles, many previously mechanical systems are being replaced with electrical or computer-controlled systems, leading to highly computerized vehicles. Connectivity is also being introduced to help connect vehicles with external networks, opening the connected car to a multitude of security problems. Current vehicles may comprise several layers of security means. For example, dedicated security controllers may be added to common vehicles networks such as the telematics control unit (TCU), to establish an end-to-end secure channel to the external world. In another example, a central gateway ECU may act as a firewall that separates the external interfaces of the vehicle from the safety-critical inner vehicle networks, so that the breaching of one area (e.g., a vehicle's infotainment system) would not gain access into critical functions, such as drive systems. In addition, the various sub-domains of the vehicle's network may comprise secure means such as a message authentication scheme, encryption, intrusion detection, and device validation.

The present disclosure comprises an IVS, or In-Vehicle STEM (security incident and event manager), as a comprehensive solution to tie together, oversee, and manage the various complex security layers and systems in a modern vehicle. The IVS, which in certain embodiments may comprise a software agent or module, collects data from a plurality of onboard data sources and outside networks. The IVS analyzes and cross-correlates data events in order to identify threats, vulnerabilities, and attack attempts in real-time on a comprehensive system-wide basis. In some embodiments, the IVS monitors, in real time: (i) events occurring in the operating system of the vehicle and/or any application running thereon; (ii) messages transmitted by electronic control units (ECUs) of various systems of the vehicle over an in-vehicle network, such as a Controller Area Network (CAN) bus and/or other vehicle communication networks; and (iii) network activity between the vehicle and external network resources.

The IVS detects anomalies and suspicious activities in the monitored data, and executes SEP on the detected suspicious events, to identify potential computer security threats based on results of the SEP. The IVS further executes edge analytics on the data, in order to minimize, prioritize, and normalize data and information transmitted to external network resources. Using a set of defined rules, the IVS may then take appropriate counter or mitigating measures in order to address any identified security threats and attack attempts. For example, the IVS can enforce a mitigation policy during an ongoing attack, by limiting outbound communications, or by disabling driver assistance systems, to reduce potential risks and mitigate the effects of the attack. Some of the mitigating measures may be taken automatically, while some may require manual intervention, e.g., by an operator of the vehicle or through an outside network resource, based on model-specific configurations and OEM specifications.

In some instances, the IVS be used as a point of trust within the vehicle, to receive commands from external network resources to allow remote control of the various onboard security and other vehicular systems. In other instances, the IVS may be configured to act autonomously, based on predefined rule policies, in the absence of active communication with external network resources. For example, in cases in which an onboard security system of the vehicle has identified a security threat and has shut down specific external communication channels. For example, such communication shutdown may include all channels, other than those connecting systems of the vehicle to the servers of OEMs. The ability of the IVS to act autonomously may also be advantageous in cases in which response quickness is paramount. Thus, in certain instances, the IVS may act locally, based on an identified threat and/or previously-received rule policies, rather than having to communicate with a remote or external network resource and await suitable commands or instructions.

The IVS may further be configured to identify and correlate data events received from onboard data sources, based on temporal event sequences; logical sequence detection; value-based constraints (e.g., the data exceeds certain value attributes); negation detection (i.e., the ability to verify the absence of certain events in an expected sequence); or based on temporal or other predetermined ‘windows’ in which a sequence of events may be captured. The IVS may be able to employ context validation functions, in connection with which the IVS may be able to evaluate the validity of a data event as a function of a current context, comprising, e.g., multiple other data events generated by various data sources of the vehicle within a certain timeframe. The IVS may also employ dynamic ‘white’ and ‘black’ IP/URL prefix addresses lists. The IVS's Stateful Event Processor may facilitate the creation of dynamic white and black lists based on membership logic. In other words, the dynamic lists will be generated and populated according to predefined algorithms that are able to learn common ‘behaviors’ of a vehicle, or common internet addresses and identities of common paired devices (e.g., mobile phones) for the vehicle in question. For example, a dynamic list of known devices may comprise all the devices that have been detected by the IVS more than a predetermined number of times within a certain time frame. Then, this dynamic list can be used to define one or more rules, such as prompting the IVS to issue an alert with respect to any paired device that is not in the known device white list. In the same way, a common IP communication white list will prompt the IVS to issue an alert regarding any new IP communication that is not in the common IP communications white list.

As noted above, the IVS is configured to provide context-based anomaly detection algorithms, flexible and configurable data upload and forwarding strategies, real time alerts, delayed transmitting of events/alerts (e.g., until WiFi connection is found), and multi-trip memory management. For example, the IVS may support events buffering and aggregation across multiple trips of the vehicle. The buffered and/or aggregated events may be stored on a persistent non-transient computer-readable storage device. Such capability may also help to facilitate orderly and swift shutdown of the IVS without loss of data. For example, the IVS may be configured such that it is capable of automatic restarting is cases of unexpected shutdown, while maintaining and preserving data integrity. Similarly, the IVS may further be configured to enable firmware updates while maintaining the integrity of logged data, generated lists, and other accumulated knowledge across updates and upgrades.

The IVS may be configured with certain security measures and features. For example, the IVS may be configured to verify and authenticate the signatures of all content received from outside network resources. The system's content, data, applications, and software integrity may advantageously be protected from being tampered with or modified in any way, including through measures aimed at preventing unauthorized access to sensitive information and data, such as IVS configurations files and policy rules, learned knowledge information (e.g., dynamic white/black lists), etc. The system may also be protected through measures aimed at preventing copying of any application logic; preventing cryptographic key exposure; and preventing insertion of malicious code aimed at exploiting the applications.

Advantageously, the IVS may comprise edge analytics capabilities. For example, the variability in type, content, and format of the information generated by individual vehicles (which may be of varying makes and models), may necessitate employing edge analytics in order to normalize and standardize the data generated and transmitted by vehicles. In addition, edge analytics may be used to prioritize the transmitted data. For example, the IVS's edge analytics may prioritize the data by assigning data type, urgency, and importance. Urgency may refer, e.g., to timeliness of the information, how quickly a response to the data is required, a need to have the data arrive prior to an event, and/or a need for promptness of action. Importance may refer to, e.g., a degree to which the data will alter or enhance a significant decision, a degree to which the data will cause a significant event, and/or an impact if the data is not delivered. Prioritization of information may involve assigning a value, wherein such values may be a range (e.g., a scale of 1-5), or expressed as low/medium/high. In some variations, data reduction strategies may also be employed, to minimize the use of limited wireless bandwidth.

A remote IVS Controller may reside on a network server and is wirelessly communicatively connected to the IVS. The IVS Controller is responsible for controlling, configuring, registering, verifying, and updating the IVS. By using the IVS Controller, the system can gain access to and control of the in-vehicle IVS, and divide the computational burden between a local vehicle software agent, third-party software running on the same or another ECU of the vehicle, and/or a remote server, so that the usage of available computational resources is optimized. The IVS may then be used as a point of trust to allow remote control of the various onboard security and other vehicular systems. For example, the IVS may receive control commands from the IVS Controller and forward the commands in a secure manner to a relevant onboard system. In some embodiments, the IVS Controller provides definitions of event types that the IVS can expect to receive from the onboard data sources. The IVS controller may also provide instructions to the IVS related to which event information should be logged persistently by the IVS when such event occurs, the latest threat intelligence that the IVS should use, and the set of rule policies that should be applied to events received from the onboard data sources. Each such rule policy has a condition and a response part. The response part will be executed if the associated condition is satisfied. Responses can comprise one or a combination of actions, such as instructing to the IVS to collect and send information in the event log to a cloud-based security incident and event manager (STEM), execute command(s) on onboard security system(s), and/or alert the operator of the vehicle. During runtime, the IVS Controller may be used for deploying these configuration files to one or more IVSs running on a fleet of vehicles.

In certain embodiments, a remote SIEM is communicatively connected to a fleet of vehicles, each comprising an IVS. The STEM collects real-time cyber threat data from the multiple IVSs of a fleet of moving vehicles spread over the road system. Automatized analysis and assessment of event data from the fleet is used to identify emerging threats and security events in real-time. The data collected by the SIEM may also enable security analysts and forensic specialists to analyze suspected attacks and identify potential vulnerabilities. A solution may then be devised and deployed across the fleet through the multiple IVSs of the fleet's vehicles, to improve the cyber security well-being of the entire fleet.

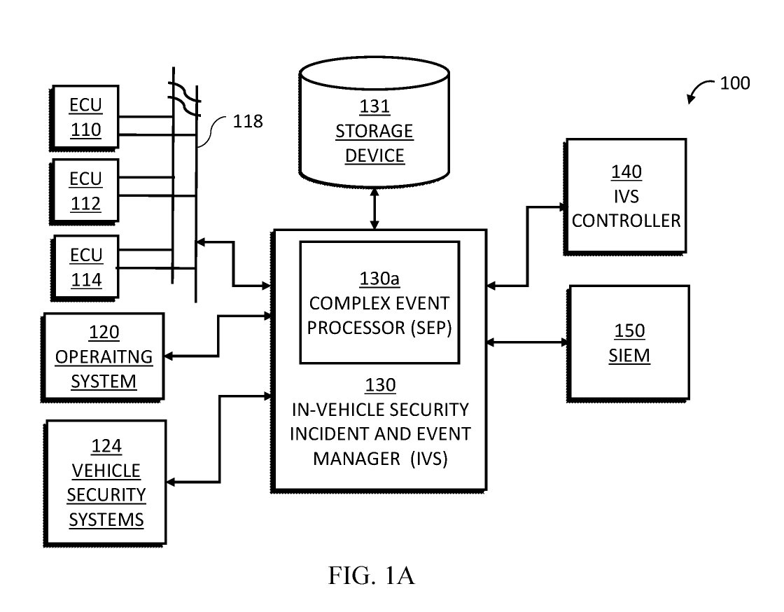

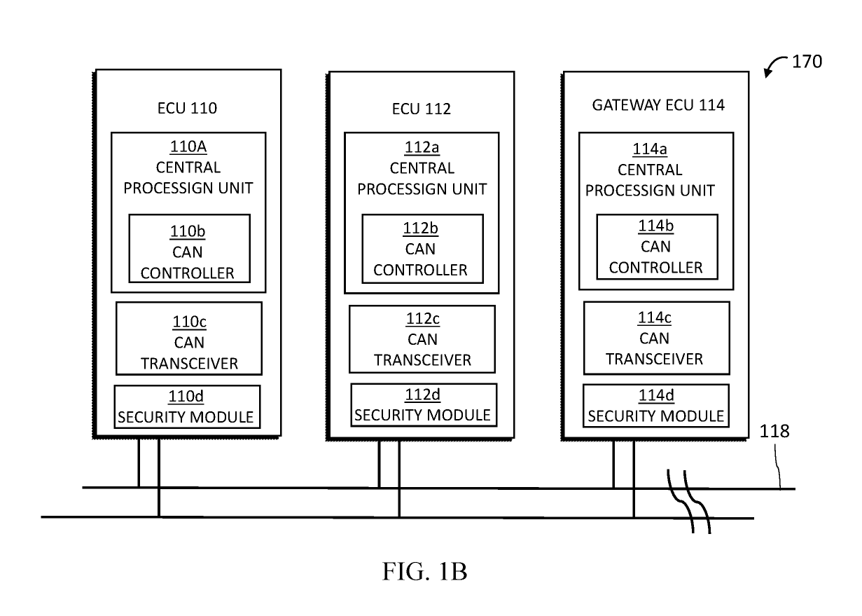

FIG. 1A is a block diagram illustrating an exemplary embodiment of the present disclosure. An In-Vehicle SIEM (IVS) 130 comprises a software module which may be hosted on an ECU of the vehicle, for example, a head unit ECU. Alternatively, the IVS may comprise a hardware device which may be communicatively connected to a vehicle network through, e.g., an On-Board Diagnostics (OBD-II) port.

The IVS may comprise a Stateful Event Processor (SEP) 130a. SEP 130a may be capable of processing multiple events in order to detect patterns among them. An event pattern is a template specifying one or more combinations of events. Given any collection of events, one or more subsets of those events may be found to match a particular pattern. Patterns may be incorporated into rule policies, which comprise a specified action upon detection of a pattern in the stream of events. IVS 130 may monitor, in real time, events occurring in a plurality of onboard data sources. Such data sources may include ECUs 110, 112, 114, with the data messages originating in such ECUs being transmitted via CAN bus 118. The data sources may also include a vehicle operating system 120 and/or applications running thereon, and vehicle security systems 124. For example, the IVS may monitor events and data from the vehicle's firewall and gateway ECU. IVS 130 may interface with the various onboard data sources (which may include third-party software and hardware) in several ways. IVS 130 may run on the same ECU as one or more vehicle data sources, or may be connected to one or more data sources via Ethernet. In such case, IVS 130 may communicate with such data sources using a suitable communication protocol. For example, the onboard data sources may forward their logs, such as key management logs and critical interfaces access logs, over an Internet Protocol (IP) network to a central logging server. The central logging server may then be configured to forward the logs sent by the onboard data sources to the IVS 130. In other cases, IVS 130 may receive messages from onboard data sources, e.g. ECUs 110, 112, 114, via CAN bus 118.

FIG. 1B illustrates an exemplary embodiment of a vehicle system 170 comprising a plurality of ECUs 110, 112, 114. It will be appreciated that a current motor vehicle may have numerous ECUs managing such systems as engine electronics; transmission electronics; chassis electronics (e.g., anti-lock braking system, traction control system); active safety (e.g., air bags); advanced driver assistance (e.g., lane assist system); passenger comfort (e.g., climate control); and infotainment systems (e.g., sounds system, navigation system). Vehicle system 170 may comprise CAN bus 118, which may be configured to connect to ECUs 110, 112, and gateway ECU 114. Optionally, CAN bus 118 enables the ECUs to communicate by sending and receiving messages. In certain embodiments, gateway ECU 114 enables communication via an Ethernet port or universal serial bus (USB). It will be appreciated that a CAN bus is one of the most common ways for vehicle ECUs to communicate. ECUs and other components, such as an IVS, connected to the CAN bus may listen to messages transmitted by other ECUs. CAN bus messages may include informative messages, for example, the Anti-Lock Brake System (ABS) receiving the speed of each wheel, or the Power Steering Control Module (PSCM) broadcasting the current position of the steering wheel. Another type of message is one requesting action of another ECU. An example of this would be the Adaptive Cruise Control (ACC) module transmitting a message regarding application of the brakes. Yet another type of message is diagnostic. Diagnostic messages are typically used for communication from a mechanic's tools to ECUs to perform actions or get diagnostic information. In certain embodiments, each of the vehicle's ECUs may comprise a central processing unit, e.g. central processing unit 110a, 112a, 114a. Each of central processing units 110a, 112a, 114a may be configured as a host processor to decide if a message broadcasted on the CAN bus 118 may be received and what messages to transmit. Optionally, each of the multiple ECUs may comprise a CAN controller, e.g. CAN controllers 110b, 112b, 114b, which are configured to store received serial bits from CAN bus 118 until an entire message is received. Each of the ECUs may further comprise a CAN transceiver, e.g. CAN transceivers 110c, 112c, 114c, which may be configured to convert data streamed from CAN bus 118 to a CAN controller level and vice-versa. In certain embodiments, each ECU may also comprise a security module 110d, 112d, 114d, which enables detecting messages received that may be an attempt of a third party to interfere with the functions of the ECU, for example a hacking of the ECU. The security module may flag the message as a suspicious message.

Referring again to FIG. 1A, in certain embodiments, IVS Controller 140 comprises a remote server communicatively connected to IVS 130 via wireless communication. IVS Controller 140 may serve as a remote point of control of IVS 130, for example, to define and deploy configuration files of IVS 130; to provide means for remotely executing a command on an onboard security system in a vehicle through IVS 130; and to provide a way to query for data stored by IVS 130. IVS 130 configuration files deployed by IVS Controller 140 may contain definitions of data events and message types that IVS 130 can expect to receive from the onboard data sources; instructions related to which data events should be logged persistently by IVS 130 when such events occur; additional extra-vehicular security and threat information that IVS 130 should use in assessing stateful events and situations; and a set of policy rules that should be applied to events received from the onboard data sources. Each such policy rule may have one or more conditions and a response part. The response part may be executed if the associated one or more conditions are satisfied. Responses may be of different types, such as: collect and send information in the event log to the security incident and event manager (SIEM), execute one or more commands on one or more onboard security systems, and/or alert the operator of the vehicle.

In some embodiments, IVS 130 may be connected to a persistent non-transient computer-readable storage device 131. Storage device 131 may be used as a log database for storing messages, events and other information, as selected by IVS 130. Storage device 131 may further be used as a rule depository for secure and persistent storage of the set of policy rules received from IVS Controller 140.

In certain embodiments, security incident and event manager (STEM) 150 may be a remote server configured for collecting real-time cyber threat data from a plurality of IVSs of a fleet of moving vehicles spread over the road system. IVS 130 communicates with STEM 150 wirelessly, e.g., through a modem associated with the motor vehicle.

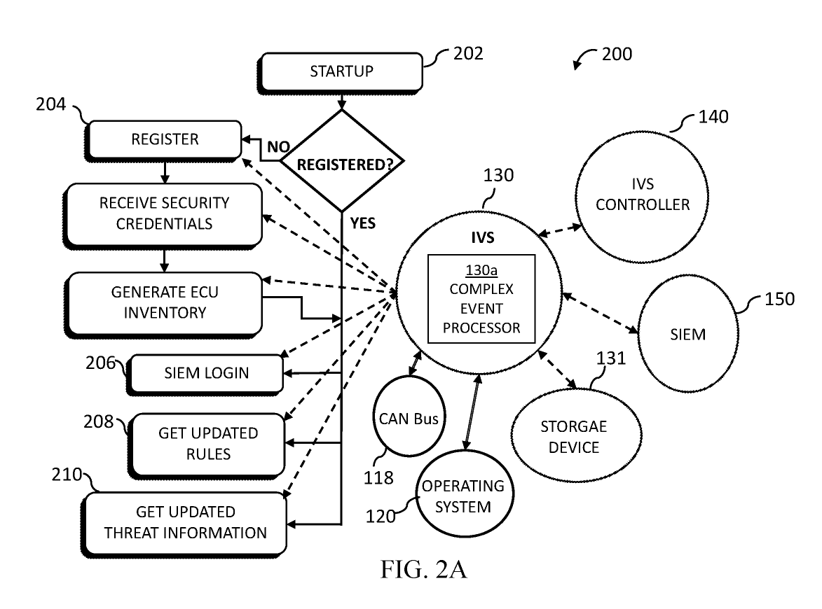

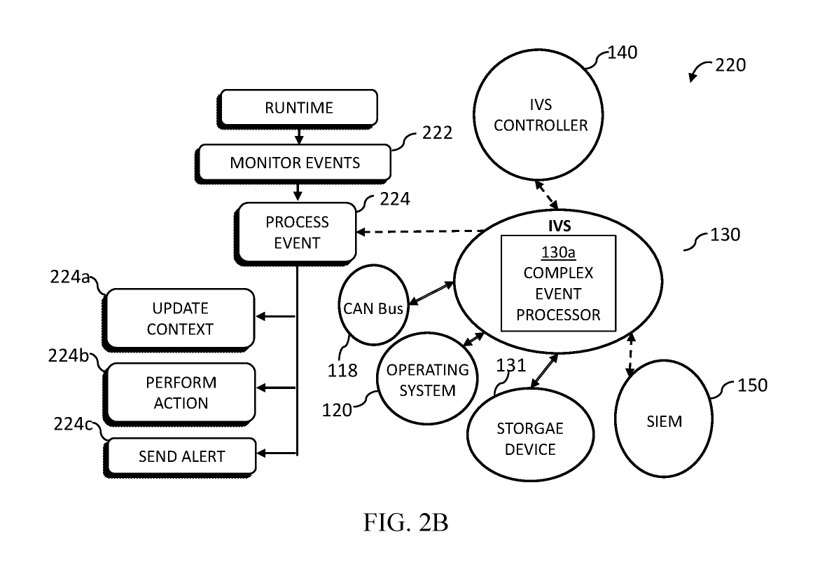

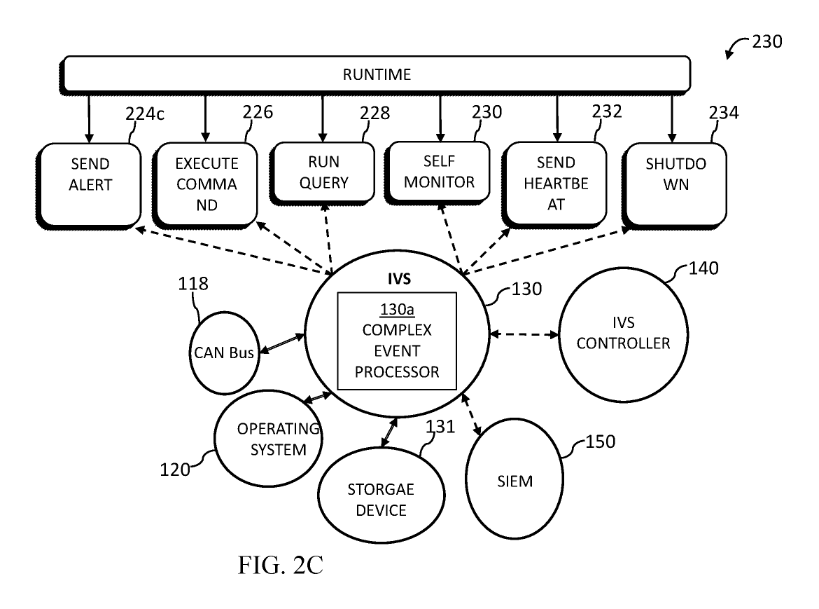

FIGS. 2A-2C illustrate several use case scenarios of a vehicle security system according to certain embodiments of the present disclosure. FIG. 2A shows a startup use case 200. Upon startup of the system in a step 202, e.g., by turning on the engine and systems of the vehicle at the beginning of a trip, IVS 130 communicates with IVS Controller 140 to checks whether it has previously registered with IVS Controller 140, and if not, perform step 204 pursuant to which IVS 130 registers with IVS Controller 140. Registration step 204 may comprise sending a register message to the IVS Controller 140, which message contains data that the IVS Controller 140 can use to identify the vehicle related to the IVS 130. Upon successful registration, the IVS Controller 140 replies with security credentials that must be used in any subsequent communications between IVS 130 and IVS Controller 140, so as to be able to authenticate the identity of the vehicle. As part of registration step 204, IVS 130 may generate an inventory of the ECUs of the vehicle comprising, e.g., the product code of each ECU and its update version. IVS 130 may send said inventory to the IVS Controller 140. Startup use case 200 may further comprise sending a login message to the security incident and event manager (SIEM) 150 in a step 206.

Startup use case 200 may then comprise a step 208 for getting the latest policy rule configuration files from IVS Controller 140. Step 208 comprises downloading the latest available policy rule configuration files from IVS Controller 140 for use in runtime event processing. In step 208, IVS 130 may send a message to IVS Controller 140 requesting a copy of the latest policy rule configuration files available for the vehicle. To verify its identity, IVS 130 may send the security credentials it received upon registration. IVS Controller 140 may then reply with a copy of the latest policy rule configuration files applicable to the vehicle. IVS 130 may check the signature of the policy rule configuration received from IVS Controller 140 to ensure that the content originated from IVS Controller 140, before acting upon the content. If the signature of the downloaded policy rule configuration file is invalid, IVS 130 logs that as an event, and may send a suitable alert to SIEM 150. In such case, IVS 130 will ignore the downloaded policy rule configuration files and continue to use the most recent valid configuration files downloaded. IVS 130 may store the received policy rule configuration files securely, e.g., in the rule depository of storage device 131. If a communication or another error occurs in the course of carrying out step 208, IVS 130 may send a suitable alert to SIEM 150, and continue to use the most recent policy rule configuration files it has successfully downloaded.

Startup step 202 may further comprise a step 210 for getting the most updated available threat intelligence and information from IVS Controller 140. IVS 130 may send a message to IVS Controller 140 requesting a copy of the latest threat intelligence available for the vehicle. IVS 130 sends the security credentials it received during registration in the message so as to be able to authenticate itself. IVS Controller 140 may then reply with a copy of the latest threat intelligence applicable to the system. IVS 130 may check the signature of threat intelligence received from IVS Controller 140 to ensure that the content originated from IVS Controller 140 before acting upon the content. IVS 130 may store the received threat intelligence, e.g., on storage device 131. If a communication or another error occurs in the course of carrying out step 210, IVS 130 may send a suitable alert to SIEM 150, and continue to use the most recent threat intelligence it has successfully downloaded.

FIG. 2B shows runtime use case scenario 220 of an exemplary embodiment of the present disclosure. In use case 220, IVS 130 continuously monitors onboard data sources, e.g., CAN bus 118 and operating system 120 and/or applications running thereon, to detect suspicious events, messages, and network activity. IVS 130 also continuously receives information from IVS Controller 140 and SIEM 150. When IVS 130 receives event data from any onboard data sources, it processes that event data in accordance with a step 224. IVS 130 may parse the event data in step 224 and perform a non-repudiation check by, e.g., verifying the signature of any event log received from an onboard data source, to ensure that the content originated from a valid onboard data source. IVS 130 may then check the timestamp associated with any event log to ensure that the event log is not one that has been replayed. IVS 130 may then, for each event in the event log, apply the latest rule policy configuration it has available to decide whether to store the event in the event log persistent store on storage device 131. In the case of any error in the carrying out of step 224, e.g., receiving an event log with an invalid signature, invalid timestamp, or error in parsing the event log, IVS 130 may send a suitable alert to SIEM 150.

Event processing step 224 may comprise stateful event processing executed by a stateful event processor (SEP) 130a. SEP 130a may continuously collect, process and analyze real-time data from onboard data sources, e.g., 120, 118. SEP 130a may focus on detecting a situation or a pattern, which can be a specific sequence or combination of events, in continuous event streams, to identify meaningful events and respond to them as quickly as possible.

In some variations, IVS 130 may monitor, for example, events and messages from an operating system of the vehicle and/or application running thereon, including, e.g., whether a USB device was inserted and/or removed from a socket of the vehicle; whether a file on such USB device contains known malware signature; whether ports of the operating system are open, which may indicate an infiltration attempt; whether an application is being executed by the operating system; whether files are being read, written, or copied to/from sensitive directories; and messages related to Bluetooth communications, such as how many Bluetooth devices are connect at a given time, which may be an indication of the number and identity of passengers in the vehicle. IVS 130 may further monitor network events, such as network usage for uploading and downloading data, which may be an indication for data infiltration/exfiltration attempts. IVS 130 may further monitor CAN bus 118 events indicating suspicious events, such as abnormal repetitive messages (based, e.g., on expected rate of messages per time frame); jamming attack attempts; or one or more unknown messages. IVS 130 may also monitor CAN bus 118 traffic to detect operational status of components of the vehicle, e.g., travelling speed; wheel speed; steering angle; engine RPM; fuel parameters; seatbelt fastening status; braking; acceleration; mirror and seat positions; and GPS location.

In some variations, IVS 130 may employ machine learning to detect regular patterns of the vehicle. For example, IVS 130, e.g., through SEP 130a, may learn typical times and durations of operation of the vehicle; typical number of passengers during various times of day; a list of authorized and/or regularly used mobile devices of vehicle operators and users; common geographic locations of travel and related times of day; patterns of driver behavior; and regular settings of driver's seat, steering wheel, and mirrors. SEP 130a may further detect and learn patterns of correlation relating to functional and operational aspects of the vehicle, e.g., correlations between steering wheel positions and the speed of each of the front wheels; correlations between braking and speed or acceleration parameters; and correlations between messages of the ABS system and vehicle speed/wheel speed parameters.

Detected patterns of correlation by SEP 130a may then involve the use of several temporally-adjacent or logically connected events and messages from various onboard data sources, the combination of which may indicate an abnormal or irregular status of the vehicle. For example, SEP 130a may correlate information regarding vehicle speed, time of day, geographic location, the number of passengers (e.g., based on airbag sensor activation), and the number of connected mobile devices, to infer whether a trip falls within regular parameters of the use of such vehicle, or may otherwise be a suspicious event. Accordingly, if the vehicle is being driven at an unusually late hour of the day, the system may flag this event as potentially suspicious. However, the system may then receive other inputs (e.g., GPS location of the vehicle; the number of passengers in the vehicle based on number of seatbelts fastened or air bag sensors activated; the number of known mobile devices connected to the vehicle) from which the system may infer, based on past patterns learned by the system, that the vehicle is simply being driven to the airport. Similarly, SEP 130a may correlate information related to vehicle speed, individual wheel speed, and ABS system sensors, to deduce whether a command to the braking system to apply emergency brakes is valid or may have originated in a malicious infiltration attempt.

Referring back to FIG. 2B, process event step 224 may include an update context step 224a. Step 224a comprises updating contexts and correlations using the received event data, as may be applicable. If an error occurs while parsing and using the context configuration, the error is logged by IVS 130, and an error report detailing the error may be sent to IVS Controller 140.

Upon receiving, parsing and logging one or more events, IVS 130 applies the detected event(s) to each policy rule that is present in the latest configuration files, to determine if any rule conditions evaluate to true as a result of the event occurring. For each such policy rule whose condition has evaluated to true, IVS 130 in a step 224b executes the corresponding response action of the policy rule. For example, step 224b may comprise performing mitigation of the detected threat. IVS 130 executes the response associated with the policy rule, to determine a command set to mitigate the threat. IVS 130 may add the command set specified in the command response to a command queue. IVS 130 may then log the overall result of the execution of the command set, and send an alert to the STEM 150 in a step 224c to indicate that the command set has been executed. In some embodiments, IVS Controller 140 may also direct IVS 130 to execute one or more commands. Such commands may include, e.g., blocking data communications to a specific IP address, issuing an alert to the operator of the vehicle to stop at the nearest possible location, operate the hazard flashing lights, etc. IVS 130 may periodically poll IVS Controller 140 to check for the next remote pending command set that it must execute. Each pending command set may contain a unique transaction identifier. IVS 130 adds the command set to be executed to its command queue. IVS 130 may then send a command response to IVS Controller 140 which contains the same transaction identifier of the command requested, together with the command result and response, if any. In some cases, an error may occur in the course of executing step 224b. For example, an error may occur while requesting the command to be executed. In such case, IVS 130 logs the error and sends an error report to IVS Controller 140. IVS 130 may also send an alert to STEM 150 to indicate the status of the command execution.

In some embodiments, IVS 130 may send a required alert to SIEM 150, e.g., as a result of event processing and command execution, as in step 224c, or otherwise, as in a step 226 of FIG. 2C. In some variations, IVS 130 may also be configured to provide an alert to the operator of the vehicle. Once IVS 130 has gathered and created the alert to be sent, IVS 130 performs rate limiting on the alert by checking to see whether the same alert has already been sent within a predetermined time window (e.g., a number of seconds). The alert rate limit time specification is retrieved from the policy rule configuration files. If no previous occurrence of the alert has happened in the rate limit time window, IVS 130 stores the alert locally in an alert store, e.g., on storage device 131, for sending to SIEM 150. IVS 130 may employ a strategy for sending alerts to SIEM 150, e.g., depending on the type of external communication connection available to IVS 130 at the time to connect to SIEM 150 (e.g., mobile broadband, Wi-Fi, home network), as well as the alert priority as defined in the policy rule configuration files. Once an alert has been confirmed to have been sent to SIEM 150, IVS 130 removes the alert from its alert store. In case of an error in sending an alert, e.g., a communication error, IVS 130 may create a second alert related to the communication error. A typical alert regarding an event may comprise an alert topic; alert priority level (e.g., high, medium, low); alert source (e.g., specific ECU of the vehicle); event metadata, if any (e.g., correlated events that were previously received and are available in the event log); and credibility of the alert. IVS 130 may be configured to guarantee that an alert response action(s) will always be persisted until the alert has been sent to SIEM 150.

Referring now to FIG. 2C, in some variations, IVS 130 may by instructed by IVS Controller 140 to execute a command, as in a step 228, on one of the onboard security systems. The command to be executed may be one from a predefined list of commands defined in the policy configuration files that are allowed to be executed on the particular onboard security system. IVS 130 may update SIEM 150 about the attempt to execute a command.

IVS Controller 140 may send one or more queries request in a step 230 to the IVS 130 to retrieve event information it had previously stored. IVS Controller 140 may create a pending queue of queries to be executed by IVS 130, and assign a unique transaction identifier to each query. IVS 130 may periodically poll IVS Controller 140 to check for a next remote pending query that it must execute. IVS Controller 140 may provide details about the query to be run to IVS 130. IVS 130 may update SIEM 150 regarding the attempt to run the query. IVS 130 may log in its system query log that it is about to execute the query. IVS 130 may then use the query parameters to determine what information needs to be queried from the event log stored, e.g., on storage device 131. IVS 130 may then log the result of the executed query in its system log and send a query response to IVS Controller 140. IVS 130 may then send a suitable alert regarding the executed query.

in some variations, IVS 130 may send periodic ‘heartbeat’ messages to SIEM 150 in a step 234, to indicate that the system is running on the relevant vehicle. In some variations, the policy rule configuration files may require a periodic ‘heartbeat’ message to be sent by IVS 130, and may specify the relevant context information to be included therein.

Upon turning off of the vehicle, e.g., when a trip has ended, IVS 130 will initiate shutdown operations in an orderly manner, as in step 236, so that when the system next starts, it can continue to operate without any impact to the vehicle information's integrity. For example, IVS 130 may receive a notification through the vehicle's CAN bus that the vehicle is being shut down. During shutdown, IVS 130 gathers certain information that is required to be sent upon shutdown, or otherwise requested by IVS Controller 140 or SIEM 150. Such information may include, e.g., the vehicle's odometer reading, or an inventory of the vehicle's ECUs and their versions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a software agent stored on a non-transient computer-readable storage medium in a motor vehicle, the software agent comprising instructions that cause a processor in the motor vehicle to:
monitor, in real time:
(i) events occurring in an operating system of the motor vehicle and any application running thereon,
(ii) messages transmitted by Electronic Control Units (ECUs) of the motor vehicle over an in-vehicle network of the motor vehicle, and
(iii) network activity between the motor vehicle and external network resources;
detect suspicious events, messages, and network activity, in the monitored events, messages, and network activity, respectively;
repeatedly execute Stateful Event Processing (SEP) on a combination of the detected suspicious events, messages, and network activity; and
infer potential computer security threats based on results of the SEP.

2. The system according to claim 1, further comprising a remote software agent controller communicatively connected to the software agent.

3. The system according to claim 1, wherein the instructions further cause the processor to execute edge analytics on the results of the SEP, and wherein said edge analytics lead to a response action selected from the group consisting of: transmitting information to the remote software agent controller, transmitting information to a remote security incident and event manager (SIEM), executing one or more commands with respect to a said ECU of the motor vehicle, and issuing an alert to an operator of the motor vehicle.

4. The system according to claim 3, wherein said edge analytics further lead to at least one of data normalization, data prioritization, and data reduction of the transmitted information.

5. The system according to claim 3, wherein the transmitted information comprises at least some of the detected suspicious events, messages, and network activity.

6. The system according to claim 5, wherein the transmitted information further comprises at least one of: (i) multiple said events temporally adjacent each of the detected suspicious events, (ii) multiple said messages temporally adjacent each of the detected suspicious messages, and (iii) said network activity temporally adjacent the detected suspicious network activity.

7. The system according to claim 2, wherein the instructions further cause the processor to receive, from the remote software agent controller, configuration files defining at least some of the suspicious events, messages, and network activity.

8. The system according to claim 7, further comprising one or more additional software agents, wherein each of said one or more additional software agents is associated with a different motor vehicle, and wherein said configuration files are based, at least in part, on suspicious events, messages, and network activity detected by at least some of said one or more additional software agents.

9. The system according to claim 7, wherein the detecting and the inferring are based, at least in part, on the received configurations files.

10. The system according to claim 7, wherein the instructions further cause the processor to log, in a persistent storage, at least some of the suspicious events, messages, and network activity, wherein the logging is based on the configuration files.

11. The system according to claim 1, wherein the instructions further cause the processor to transmit information to at least one of the remote software agent controller and the SIEM in response to an information request query.

12. The system according to claim 1, wherein the instructions further cause the processor to detect a malfunctioning system of the vehicle, based on the results of the SEP.

13. The system according to claim 1, wherein the instructions further cause the processor to generate an inventory of said ECUs of the motor vehicle and transmit said inventory to the remote software agent.

14. A method comprising using at least one hardware processor of a motor vehicle for:
monitoring, in real time:
(i) events occurring in an operating system of the motor vehicle and any application running thereon,
(ii) messages transmitted by Electronic Control Units (ECUs) of the motor vehicle over an in-vehicle network of the motor vehicle,
(iii) network activity between the motor vehicle and external network resources;
detecting suspicious events, messages, and network activity, in the monitored events, messages, and network activity, respectively;
repeatedly executing Stateful Event Processing (SEP) on a combination of the detected suspicious events, messages, and network activity; and
inferring potential computer security threats based on results of the SEP.

15. The method according to claim 14, further comprising communicating with a remote software agent controller.

16. The method according to claim 14, further comprising executing edge analytics on the results of the SEP, wherein said edge analytics lead to a response action selected from the group consisting of: transmitting information to the remote software agent controller, transmitting information to a remote security incident and event manager (SIEM), executing one or more commands with respect to a said ECU of the motor vehicle, and issuing an alert to an operator of the motor vehicle.

17. The method according to claim 16, wherein said edge analytics further lead to at least one of data normalization, data prioritization, and data reduction of the transmitted information.

18. A computer program product, the computer program product comprising a non-transitory computer-readable storage medium in a motor vehicle having program code embodied therewith, the program code executable by at least one hardware processor in the motor vehicle to:
monitor, in real time:
(i) events occurring in an operating system of the motor vehicle and any application running thereon,
(ii) messages transmitted by Electronic Control Units (ECUs) of the motor vehicle over an in-vehicle network of the motor vehicle, and
(iii) network activity between the motor vehicle and external network resources;
detect suspicious events, messages, and network activity, in the monitored events, messages, and network activity, respectively;
repeatedly execute Stateful Event Processing (SEP) on a combination of the detected suspicious events, messages, and network activity; and
infer potential computer security threats based on results of the SEP.

19. The computer program product according to claim 18, further comprising executing edge analytics on the results of the SEP, wherein said edge analytics lead to a response action selected from the group consisting of: transmitting information to a remote software agent controller, transmitting information to a remote security incident and event manager (SIEM), executing one or more commands with respect to a said ECU of the motor vehicle, and issuing an alert to an operator of the motor vehicle.

20. The computer program product according to claim 19, wherein said edge analytics further lead to at least one of data normalization, data prioritization, and data reduction of the transmitted information.
